(19) United States
(12) Patent Application Publication
(10) Pub. No.: US 2026/0282099 A1
(43) Pub. Date: Sep. 17, 2026

(54) DEVICES AND METHODS FOR FREQUENCY HOPPING FOR PRACH REPETITION

(71) Applicant: Lenovo (Beijing) Limited, Beijing (CN)

(72) Inventors: Yuantao Zhang, Beijing (CN); Ruixiang Ma, Beijing (CN); Zhi Yan, Beijing (CN); Yingying Li, Beijing (CN)

(73) Assignee: Lenovo (Beijing) Limited, Beijing (CN)

(21) Appl. No.: 19/168,020

(22) PCT Filed: Apr. 7, 2023
(86) PCT No.: PCT/CN2023/087042

§ 371 Date: Sep. 23, 2025

(51) Int. Cl. H04W 74/0833; H04B 1/7156; H04L 5/00; H04W 74/00

(52) U.S. Cl. CPC H04W 74/0833; H04B 1/7156; H04L 5/0005; H04W 74/004

(57) ABSTRACT

Embodiments of the present disclosure relate to devices, methods, and a non-transitory computer readable medium for frequency hopping of PRACH repetition. A terminal device receives, via a transceiver, a configuration for Physical Random Access Channel (PRACH) repetition. The terminal device performs a frequency hopping operation of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs. In this way, ROs for the PRACH repetition are configured in different frequency positions, and thus the detection performance of a signal transmitted with PRACH repetition is improved.

### FIELD

Embodiments of the present disclosure generally relate to the field of communication, and in particular to devices, methods, and a non-transitory computer readable medium for frequency hopping for Physical Random Access Channel (PRACH) repetition.

### BACKGROUND

In communication technology, there is a constant evolution ongoing in order to provide efficient and reliable solutions for utilizing wireless communication networks. Currently, efforts have been made to develop 5th generation (5G) or 5G advance wireless system. The new wireless systems can support various types of service applications for terminal devices.

In 5G New Radio (NR) system, a random access (RA) procedure is utilized for various purposes. The random access procedure is utilized by the UE in initial access to find a cell to camp on, or utilized by a Radio Resource Control (RRC) IDLE/INACTIVE UE to switch to RRC Connected to start data transmission/reception, or utilized by a RRC Connected UE to re-establish the lost UL synchronization, etc.

### SUMMARY

In general, example embodiments of the present disclosure provide devices, methods and a computer readable medium for frequency hopping for PRACH repetition.

In a first aspect, there is provided a terminal device. The terminal device comprises a processor and a transceiver coupled to the processor. The processor is configured to receive, via the transceiver, a configuration for Physical Random Access Channel (PRACH) repetition; and perform a frequency hopping operation of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In a second aspect, there is provided a network device. The network device comprises a processor and a transceiver coupled to the processor. The processor is configured to transmit, via the transceiver, to a terminal device, a configuration for Physical Random Access Channel (PRACH) repetition; and perform a frequency hopping operation of reception of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In a third aspect, there is provided a method performed by a terminal device. The method comprises receiving, via a transceiver, a configuration for Physical Random Access Channel (PRACH) repetition; and performing a frequency hopping operation of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In a fourth aspect, there is provided a method performed by a network device. The method comprises transmitting, via a transceiver, to a terminal device, a configuration for Physical Random Access Channel (PRACH) repetition; and performing a frequency hopping operation of reception of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In a fifth aspect, there is provided an apparatus for communication. The apparatus comprising means for performing the method according to the third aspect above.

In a sixth aspect, there is provided an apparatus for communication. The apparatus comprising means for performing the method according to the fourth aspect above.

In a seventh aspect, there is provided a non-transitory computer readable medium. The non-transitory computer readable medium having program instructions stored thereon. The program instructions, when executed by an apparatus, causing the apparatus at least to perform the method according to the third aspect or the fourth aspect above.

In an eighth aspect, there is provided a computer program product. The computer program product comprises instructions. The instructions, when executed by a processor of an apparatus, causing the apparatus at least to perform the method according to the third aspect or the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1A illustrates an example network environment in which some embodiments of the present disclosure can be implemented;

FIG. 1B illustrates an example procedure for a NR 4-step random access procedure;

FIG. 1C illustrates an example on the structure of overall random access channel (RACH) resource;

FIG. 1D illustrates example associations between ROs and SSBs;

FIG. 2 illustrates an signaling chart of an example process according to some embodiments of the present disclosure;

FIG. 3 illustrates an example of frequency hopping for PRACH repetition according to some embodiments of the present disclosure;

FIG. 4A illustrates another example of frequency hopping for PRACH repetition according to some embodiments of the present disclosure;

FIG. 4B illustrates further example of frequency hopping for PRACH repetition according to some embodiments of the present disclosure;

FIG. 5A illustrates further example of frequency hopping for PRACH repetition according to some embodiments of the present disclosure;

FIG. 5B illustrates yet example of frequency hopping for PRACH repetition according to some embodiments of the present disclosure;

FIG. 6 illustrates an example SSB to RO association in an SSB to RO association period;

FIG. 7 illustrates example SSB to RO mapping patterns without changing the legacy SSB to RO association;

FIG. 8 illustrates example SSB to RO mapping patterns with changing the legacy SSB to RO association according to some embodiments of the present disclosure;

FIG. 9 illustrates a flowchart of an example method implemented at a terminal device according to some embodiments of the present disclosure;

FIG. 10 illustrates a flowchart of an example method implemented at a network device according to some embodiments of the present disclosure; and

FIG. 11 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term “resource,” “transmission resource,” “resource block,” “physical resource block,” “uplink resource,” or “downlink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

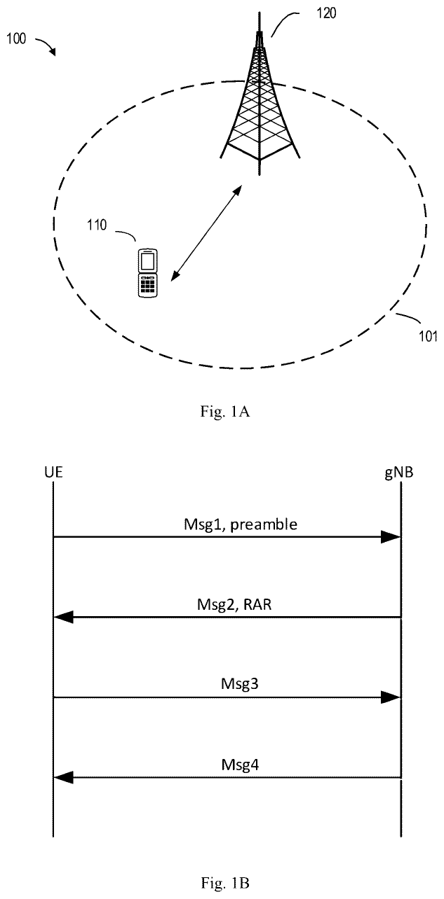

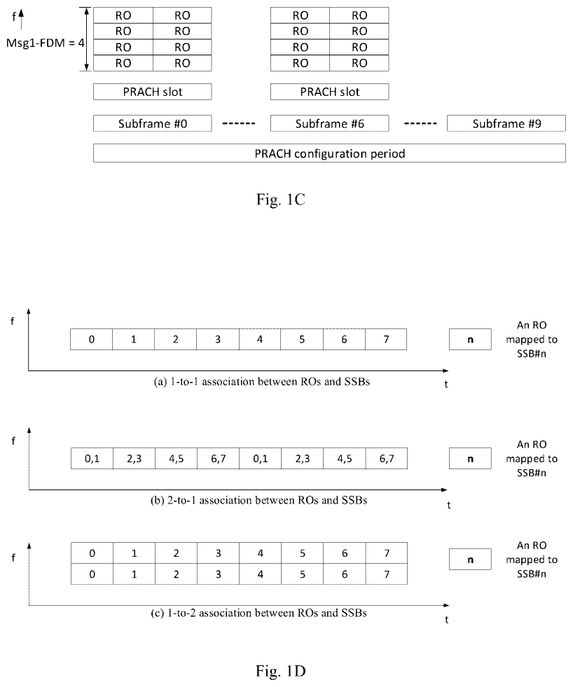

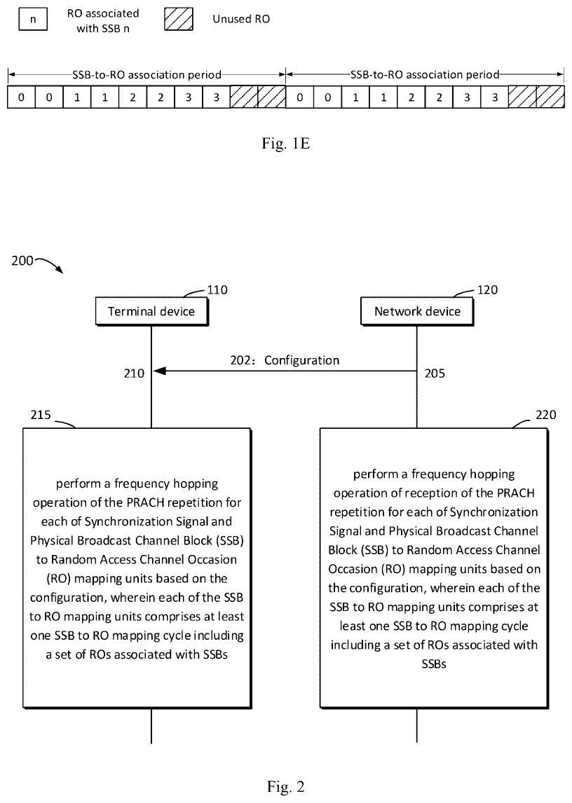

FIG. 1A illustrates an example network environment 100 in which example embodiments of the present disclosure may be implemented. The environment 100, which may be a part of a communication network, comprises terminal devices and network devices.

As illustrated in FIG. 1A, the communication network 100 may comprise a terminal device 110 (hereinafter may also be referred to as user equipment 110 or the UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As discussed above, the random access procedure may be utilized for various purposes in 5G NR system. Only for illustrative purposes, reference will made to FIG. 1B, which illustrates an example procedure for NR 4-step random access procedure.

As illustrated in FIG. 1B, in the NR 4-step random access procedure, the UE (e.g., the terminal device 110) firstly transmits a Msg1 preamble to the gNB (e.g., the network device 120), and then receives a Random Access Response (RAR) in Msg2, which may indicate a reception of the preamble, or provide necessary information for the transmission of Msg3. The Msg3 and Msg4 are transmitted to solve potential collisions due to simultaneous transmissions of the same preamble from different UEs.

The PRACH Msg1 transmission takes place in Random Access Channel (RACH) occasions (ROs), each of which occupies one or multiple consecutive resource blocks. In the time domain, the ROs are configured in every PRACH configuration period, which contains a set of radio frames. Within a PRACH configuration period, a subset of subframes is indicated to contain a set of PRACH slots, and within each PRACH slot, there might be a set of RACH occasions available for PRACH Msg1 transmission.

Besides, in the frequency domain, the BS may configure Frequency Domain Multiplexed (FDMed) ROs, which are multiplexed in the frequency domain. The signaling parameter msg1-FDM is used to indicate the number of FDMed ROs in one time unit (or one time instance, e.g., a slot or a sub-slot). The position of each PRACH occasion in frequency domain is determined based on another signaling parameter msg1-FrequencyStart, which indicates the offset of lowest RO in frequency domain with respective to Physical Resource Block (PRB) 0 of the UL Bandwidth Part (BWP).

FIG. 1C illustrates an example on the structure of overall RACH resource. Herein, a PRACH configuration period may contain 10 subframes, among which both subframe #0 and subframe #6 contain PRACH slots. Each PRACH slot is configured with 2 ROs in the time domain and 4 ROs (msg1-FDM=4) in the frequency domain.

The ROs may be associated with SSBs that may be associated with or transmitted with different beams. The SSBs comprise primary synchronization signal/secondary synchronization signal (PSS/SSS) and Physical Broadcast Channel (PBCH) for the UE to synchronize to the downlink (DL), obtain the cell identify (ID), and acquire system information. The UE will measure the channel status of each SSB, select one among them with a good channel quality, and transmit a preamble in a RO that is associated with the SSB. The indexes of available SSBs may be obtained in the system information.

FIG. 1D illustrates example associations between ROs and SSBs. The association of SSBs (beams) and ROs could be 1-to-1, i.e., one SSB is associated with one RO and one RO is associated with one SSB, for example as illustrated in (a) of FIG. 1D). The association of SSBs (beams) and ROs could be N-to-1 i.e., more than one SSB is associated with one RO, for example 2-to-1 as illustrated in (b) of FIG. 1D. The association of SSBs (beams) and ROs could be 1-to-N, i.e., a single SSB is associated with more than one RO. For example, in (c) of FIG. 1D, one SSB may be associated with two FDMed ROs and thus it is a 1-to-2 association. In addition, one SSB may be associated with two ROs in two different time units or instances.

The association of SSBs (beams) and ROs may depend on network configuration. This is determined by a signaling parameter SSB-PerRACH-Occasion, which indicates the number of SSBs that are mapped to one PRACH occasion. In examples for each type of association as illustrated in FIG. 1D, if 8 SSBs (0~7) are assumed, the parameter SSB-PerRACH-Occasion=1, 2, ½ in (a)/(b)/(c) of FIG. 1D, respectively.

The SSB to RO association is performed periodically in each SSB to RO association period. One association period is X times of the PRACH configuration period and contains one or multiple SSB-to-RO mapping cycles, wherein X denotes an integer equal to or larger than one. The SSB to RO association period consists of a sequence of ROs to which all available SSBs are mapped and may include one or more SSB-to-RO mapping cycles. The association period may refer to a period of repetition of the SSB to RO associations. The duration of the association period may be the minimum period such that within the association period, each SSB is associated with at least one RO.

Within an association period, there might be some ROs that are not associated with any SSBs, these ROS are unused ROs, i.e., ROs not used for any PRACH transmission.

FIG. 1E illustrates example associations between ROs and SSBs. As illustrated in FIG. 1E, there are two SSB to RO association periods, each of which comprises two SSB mapping cycles. There are two unused ROs within each association period.

For example, a first SSB to RO association period (e.g., the left one in FIG. 1E) comprises a cycle comprising the first RO associated with SSB 0, the third RO associated with SSB 1, the fifth RO associated with SSB 2, and the seventh RO associated with SSB 3. The first SSB to RO association period further comprises another cycle comprising the second RO associated with SSB 0, the fourth RO associated with SSB 1, the sixth RO associated with SSB 2, and the eighth RO associated with SSB 3. In the first SSB to RO association period, the ninth and tenth ROs are unused.

Current 5G NR supports a preamble transmission without repetition. However, the inventive noticed that PRACH might be the bottleneck channel if a short PRACH format is used. Therefore, study has been undergoing on how to improve the coverage of PRACH. One efficient way is to support the PRACH repetition, for example to have repeated PRACH transmissions with same beam (i.e., in ROs associated with same SSB) in each repetition.

The PRACH repetition cannot be transmitted in the FDMed ROs in the same time instance, or should be avoided to transmit in the FDMed ROs as much as possible. Otherwise there will be little or even no performance improvement on PRACH detection due to transmit power division in the FDMed ROs in the same time instance.

In addition, the inventive notice that frequency hopping is one efficient method to improve the detection performance of a signal that is transmitted with repetition because of additional frequency diversity gain provided frequency hopping. Frequency hopping may be considered in the PRACH repetition, and ROs for PRACH repetition may be configured in different frequency positions. In the present disclosure, this may be also called as RO hopping for PRACH repetition.

In view of the above discussions, embodiments of the present disclosure provide solutions for frequency hopping for PRACH repetition. In one aspect of the solution of the present disclosure, a terminal device receives, via a transceiver, a configuration for Physical Random Access Channel (PRACH) repetition. The terminal device performs a frequency hopping operation of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In this way, ROs for the PRACH repetition can be configured in different frequency positions, thereby the detection performance of a signal transmitted with PRACH repetition is improved.

In Principles and implementations of embodiments of the present disclosure will be described in detail below with reference to FIGS. 2-11. It is to be appreciated that the solutions as proposed in the present disclosure are described with reference to example methods and apparatus, only for illustrative purposes; however, the embodiments of the present disclosure are not limited thereto and they may be applied to other applications or scenarios with similar issues to XR applications.

### EXAMPLE METHOD

FIG. 2 illustrates an example chart illustrating an example process 200 according to some embodiments of the present disclosure. For the purpose of discussion, the example 200 will be described with reference to FIG. 1A.

In the example process 200, a network device 120 transmits 205 a configuration 202 for PRACH repetition to a terminal device 110. The configuration may indicate frequency hopping parameters for PRACH repetition. Correspondingly, the terminal device 110 receives 210 the configuration 202 for PRACH repetition. Then, the terminal device 110 performs 215 a frequency hopping operation of the PRACH repetition for each of SSB to RO mapping units based on the configuration. Each of the SSB to RO mapping units comprises at least one SSB to RO mapping cycle including a set of ROs associated with SSBs. Moreover, the network device 120 performs 220 a frequency hopping operation of repetition of the PRACH repetition for each of SSB to RO mapping units based on the configuration. Each of the SSB to RO mapping units comprises at least one SSB to RO mapping cycle including a set of ROs associated with SSBs.

In some embodiments, the terminal device 110 may determine a set of ROs for PRACH repetition, wherein each RO in the set of ROs is mapped to a same SSB. The terminal device 110 may determine the SSB to RO mapping unit for each RO in the set of ROs for PRACH repetition.

For example, ROs configured for PRACH repetition are grouped into a plurality of sets, where each RO in a plurality of set is mapped to a same SSB. For example, for a specific SSB 0, a first set of ROs may include RO#0 to RO#1, a second set of ROs may include RO#2 and RO#3, and so on.

Then, one or multiple sets of ROs are determined for PRACH repetition. The terminal device 110 may further determine which SSB to RO mapping unit each RO in such set(s) is associated with, where one RO can only be associated to one SSB to RO mapping unit. For example, for each of the first set of ROs associated with SSB 0, the terminal device may determine one SSB to RO mapping unit with which the RO is associated.

In some embodiments, the terminal device 110 may determine a frequency position of an RO in a SSB to RO mapping unit based on an index of the SSB to RO mapping unit.

It is proposed that if frequency hopping is enabled for PRACH repetition, the frequency hopping may be performed for every K SSB to RO mapping cycles. The value of K is either predefined, or configured (in the system information), or implicitly determined, wherein K>=1. In addition, at least one frequency offset will be configured to the UEs for the frequency hopping, based on which the UE can decide positions of ROS in each of K SSB to RO mapping cycles in the frequency domain.

In some embodiments, the terminal device 110 may determine the frequency position of the RO in the SSB to RO mapping unit from a start frequency position of the RO in the SSB to RO mapping unit and a frequency offset based on the index of the SSB to RO mapping unit.

In some embodiments, the start frequency position of the RO in the SSB to RO mapping unit may be determined by at least a start frequency position for the PRACH repetition. For example, the start frequency position of the RO in the SSB to RO mapping unit may be determined by at least msg1-FrequencyStart, which indicates the start frequency position of the lowest RO in frequency domain with respective to PRB 0 of the UL BWP.

In some embodiments, the terminal device 110 may configured with a single frequency offset. Moreover, when the index of the SSB to RO mapping unit is even, the terminal device 110 may further determine the frequency position based on the start frequency position of the RO in the mapping unit. When the index of the SSB to RO mapping unit is odd, the terminal device 110 may further determine the frequency position based on the start frequency position of the RO in the mapping unit and the single frequency offset. It is noted that, the operations can be in an opposite way. For example, when the index of the SSB to RO mapping unit is odd, the terminal device 110 may further determine the frequency position based on the start frequency position of the RO in the mapping unit. When the index of the SSB to RO mapping unit is even, the terminal device 110 may further determine the frequency position based on the start frequency position of the RO in the mapping unit and the single frequency offset.

For example, only one frequency offset is configured to the UE, and the frequency hopping is performed every SSB to RO mapping cycle, i.e., K is predefined or determined as 1. The SSB to RO mapping cycles are indexed. The indexing starts from the first SSB to RO mapping cycle starting from frame #0. The frequency position of ROs in each SSB to RO mapping cycle can be determined as follows:
For an even index SSB to RO mapping cycle, i.e., mod (I_cycle, 2)=0, the ROs of the mapping cycle start from the start frequency position of the RO (F_start), which is determined based on the configured msg1-FrequencyStart. I_cycle is the index of the SSB to RO mapping cycle.
For an odd index SSB to RO mapping cycle, i.e., mod (I_cycle, 2)=1, the ROs of the mapping cycle start F_start+offset, or mod (F_start+offset, BWP_size), where “offset” is the configured frequency offset for RO hopping, and BWP_size is the number of ROs included in the active UL BWP.

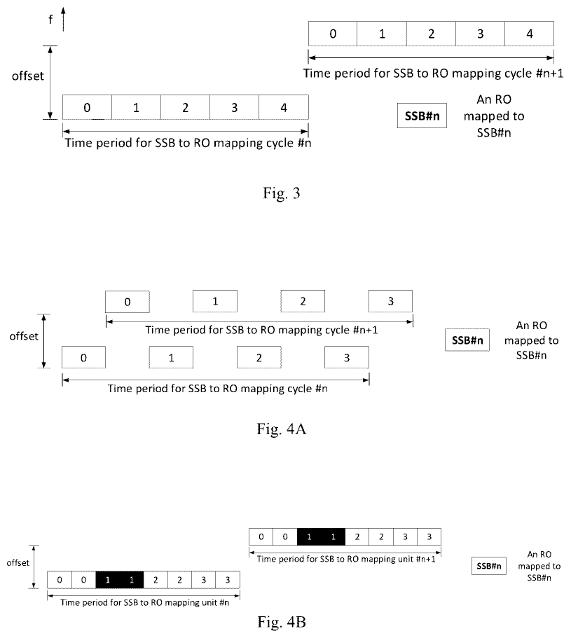

Only for illustrative purposes, reference will be made to FIG. 3 to describe an example of frequency hopping for PRACH repetition according to some embodiments of the present disclosure. In the example, only one hopping offset is configured for the UE. Frequency hopping is performed every K=1 mapping cycle. In the example of FIG. 3, for an SSB to RO mapping cycle #n (n is an even number), the frequency position of the ROs starts from the configured msg1-FrequencyStart. For an SSB to RO mapping cycle #n+1, the frequency position of the ROs starts from the configured msg1-FrequencyStart+offset, or mod (msg1-FrequencyStart+offset, BWP_size).

For example, in FIG. 3, one SSB to RO mapping cycle may be taken as one SSB to RO mapping unit. If the UE selects SSB#1, the two ROs mapped to SSB#1 (i.e., the second ROs in each SSB to RO mapping cycle) are used for PRACH repetition, as shown in FIG. 3. The two ROs might be in a same set of ROs for PRACH repetition.

FIG. 4A illustrates an example of frequency hopping for PRACH repetition according to some embodiments of the present disclosure. In the example, only one hopping offset is configured for the UE. RO hopping is performed every K=1 mapping cycle, as shown in FIG. 4A. In this example, one SSB to RO mapping cycle may be taken as the SSB to RO mapping unit.

In the example of FIG. 4A, for SSB to RO mapping cycle #n (n is an even number), the frequency position of the ROs starts from the configured msg1-FrequencyStart. For SSB to RO mapping cycle #n+1, the frequency position of the ROs starts from the configured msg1-FrequencyStart+offset, or mod (msg1-FrequencyStart+offset, BWP_size). For example, the UE selects SSB#1, the two ROs mapped to SSB#1 are used for PRACH repetition, as shown in FIG. 4A.

In another example, only one frequency offset is configured to the UE, but frequency hopping is performed every more than one SSB to RO mapping cycles, i.e., K>1. In this example, K SSB to RO mapping cycles may be taken as a mapping unit.

The SSB to RO mapping units may be indexed and the frequency position of ROS in each SSB to RO mapping unit can be determined based on the indexes of the SSB to RO mapping units as follows:
For an even index SSB to RO mapping unit, i.e., mod (I_unit, 2)=0, the ROs of the mapping cycle start from F_start, which is determined based on the configured msg1-FrequencyStart.

For an odd index SSB to RO mapping unit, i.e., mod (I_unit, 2)=1, the ROs of the mapping cycle start from F_start+offset, or mod (F_start+offset, BWP_size).

FIG. 4B illustrates further example of frequency hopping for PRACH repetition according to some embodiments of the present disclosure. In the example, only one hopping offset is configured for the UE. The RO hopping is performed every K=2 mapping cycles, as shown in FIG. 4B. For example, if the UE selects SSB#1, the four ROs mapped to SSB#1 are used for PRACH repetition, as shown in FIG. 4B.

In some embodiments, the terminal device 110 may be configured with at least two offsets. Moreover, the terminal device 110 may further determine the frequency position from a result of mod the index of SSB to RO mapping unit by a number of the at least two offsets and the start frequency position for the PRACH repetition.

From UE's point of view, the UE needs to determine the frequency position of the ROs involved in the PRACH repetition. For the examples described above, from the configuration, the starting RO is always included in an SSB to RO mapping cycle or mapping unit with even index, for example unit #n, wherein n=0, 2, . . . . Therefore, the UE determines the frequency position of the starting RO based on the configured msg1-FrequencyStart. If there are ROs included in the next SSB to RO mapping cycle or mapping unit with odd index, for example unit #n+1, the UE determines the frequency position of the ROs based on the configured msg1-FrequencyStart+offset, or mod (msg1-FrequencyStart+offset, BWP_size).

For example, assume that more than one frequency offsets are configured to the UE, the frequency hopping is performed every K SSB to RO mapping cycles, K>1 and K SSB to RO mapping cycles can be taken as a mapping unit. The BS configures L frequency offsets, where L>=2. The frequency position of ROs in each SSB to RO mapping unit can be determined as follows,
For a mapping unit fulfilling mod (I_unit, L)=0, the ROs of the mapping unit starts F_start, which is determined from the configured msg1-FrequencyStart.
For a mapping unit fulfilling mod (I_unit, L)=1, the ROs of the mapping unit starts from F_start+offset_1, or mod (F_start+offset_1, BWP_size).
. . .
For a mapping unit fulfilling mod (I_unit, L)=N_offset-1, the ROs of the mapping unit starts from F_start+offset_L-1, or mod (F_start+offset L-1, BWP_size).

In some embodiments, if RO hopping is configured, the indexing of the SSB to RO mapping cycles or mapping units are started from the first mapping cycle or mapping from frame 0. In some other embodiments, the indexing of the SSB to RO mapping cycles or mapping units are started or restarted in each SSB to RO association period. For example, PRACH repetition happens among the SSB to RO mapping cycles within each SSB to RO association period.

In some embodiments, the frequency hopping operation is performed based on a number of SSB to RO mapping cycles in the SSB to RO mapping unit and a configured number of PRACH repetitions.

In some embodiments, the terminal device 110 may perform the frequency hopping operation when a number of SSB to RO mapping cycles in the SSB to RO mapping unit is less than or equal to the configured number of PRACH repetitions. Alternatively, the terminal device 110 may cancel the frequency hopping operation when the number of SSB to RO mapping cycles in the SSB to RO mapping unit is larger than the configured number of PRACH repetitions.

In some embodiments, the value K depends on the configured number of PRACH repetitions. If the determined K is larger than the configured PRACH repetition number, frequency hopping will not be performed in this case.

In some embodiments, a number of SSB to RO mapping cycles in an SSB to RO mapping unit is either predefined, or configured. Or additionally or alternatively, it may be determined by at least one of: a number of SSBs configured for mapping of configured ROs, a number of ROs multiplexed in frequency domain, and a number of SSBs mapped to a single RO.

For the cases that K is implicitly determined, it is proposed that K is determined by at least one of the parameters N_SSB, msg1-FDM and SSB-perRach-Occasion, where N_SSB is the number of SSBs configured for mapping of ROs, msg-FDM is the number of FDMed ROs in frequency domain, and SSB-perRach-Occasion configures the number of SSBs that are mapped to one RACH occasion.

Such proposal is based on the principle that PRACH repetition cannot be performed in the FDMed ROs, or PRACH repetition should be avoided to transmit in the FDMed ROs as much as possible. As a result, the frequency hopping should not be performed among FDMed ROs in the same time instance that are associated with a same SSB.

Based on this, the value of K is determined based on if the number of ROs per each mapping cycle (which can be calculated by N_SSB/SSB-perRach-Occasion, as in below) is larger than the number of FDMed ROs or not.

In some embodiments, a number of ROs per SSB to RO mapping cycle may be less than or equal to the number of ROs in frequency domain. The terminal device 110 may further determine the number of SSB to RO mapping cycles in the SSB to RO mapping unit as a ratio of the number of ROs multiplexed in frequency domain and the number of ROs per SSB to RO mapping cycle.

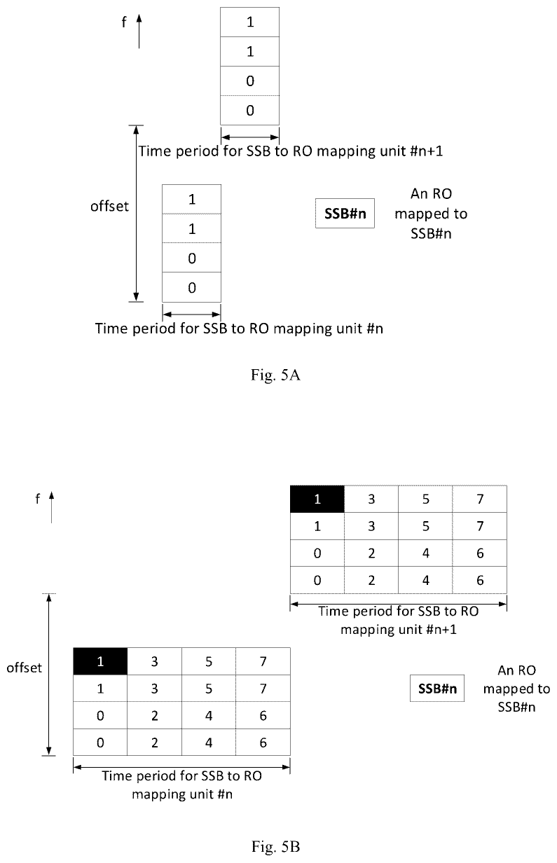

If the number of the ROs per mapping cycle (hereinafter may also be referred to as M) is less than the number of FDMed ROs, there will be FDMed ROs mapped to the same SSB, for example, as shown FIG. 5A. Frequency hopping cannot be performed among these FDMed ROs (or between the two mapping cycles that include these ROs). Therefore, the mapping cycles that contains FDMed ROs in the same time instance that are mapped to a same SSB should be grouped to be one mapping unit for the hopping operation.

If M<=msg1-FDM, which means that the number of ROs involved in a mapping cycle is less than the number of FDMed ROs, K=ceil (msg1-FDM/M).

In some embodiments, the number of ROs per SSB to RO mapping cycle may be equal to the number of SSBs configured for mapping of configured ROs. As shown in FIGS. 3 and 4A, N=4 and msg1-FDM=1 and in such a case the number of ROs per SSB to RO mapping cycle is equal to 4.

Alternatively, in some embodiments, the number of ROs per SSB to RO mapping unit may equal to a ratio of the number of SSBs configured for mapping of configured ROs and the number of SSBs mapped to a single RO. As show in FIG. 4B, for example, N=4 and msg1-FDM=1 and in such a case the number of ROs per SSB to RO mapping cycle is equal to 4.

In some embodiments, M=N_SSB/SSB-perRACH-Occasion, i.e., M is the number of ROs that are included in one SSB to RO mapping cycle.

If the number of the ROs per mapping cycle M is larger than the number of FDMed ROs, there may or may not be FDMed ROs mapped to the same SSB in the same time instance. This depends on the configuration of msg1-FDM and SSB-perRach-Occasion.

In some embodiments, the number of ROs per SSB to RO mapping cycle may be larger than the number of ROs FDMed in the frequency domain. Moreover, the terminal device 110 may further determine the number of SSB to RO mapping cycles in the SSB to RO mapping unit as a ratio of 1 and the number of SSBs mapped to a single RO, when the number of ROs FDMed in the frequency domain is larger than 1. The terminal device 110 may further determine the number of SSB to RO mapping cycles in the SSB to RO mapping unit as 1, when the number of ROs FDMed in the frequency domain is equal to 1 and the number of SSBs mapped to a single RO is larger than 1.

For msg1-FDM >1, (no matter SSB-perRach-Occasion <1 or >=1), if two or more mapping cycles that contain FDMed ROs in the same time instance that are mapped to a same SSB, they should be grouped to be one mapping unit for the hopping operation.

For msg1-FDM >1, if there are no mapping cycles that contain FDMed ROs in the same time instance that are mapped to a same SSB, or msg1-FDM=1, the hopping can be performed every SSB to mapping cycle. Alternatively, for msg1-FDM=1, if SSB-perRach-Occasion<1, K could be 1/SSB-perRach-Occasion.

If M>msg1-FDM, which means that the number of ROs involved in a mapping cycle is larger than the number of FDMed ROs, K=1/SSB-perRACH-Occasion, if 1/SSB-perRACH-Occasion>1, K=1 otherwise.

FIG. 5B illustrates yet example of frequency hopping for PRACH repetition according to some embodiments of the present disclosure. In the example, only one hopping offset is configured for the UE. According to the proposal, frequency hopping is performed every K=1/SSB-perRACH-Occasion=2 mapping cycles. That is, one SSB to RO mapping unit contains two SSB to RO mapping cycles. For the SSB to RO mapping unit #n (n is an even number), the frequency position of the RO starts from F_start, which is determined based on the configured msg1-FrequencyStart. For the SSB to RO mapping unit #n+1, the frequency position of the RO starts from F_start+offset, or mod (F_start+offset, BWP_size). For example, the UE selects SSB#1, the two ROs mapped to SSB#1 are used for PRACH repetition, as shown in the figure.

With the solution as proposed herein, the PRACH repetition may be performed at different frequency positions, and additional frequency diversity gain may be obtained, and thus the transmission performance of a PRACH transmission may be improved.

In some embodiments, each of the SSB to RO mapping units may have a same SSB to RO mapping pattern. The same mapping pattern may indicate a same number of ROs and a same SSB to RO association for each RO.

In some cases, e.g., when M (=N_SSB/SSB-perRach-Occasion) is not an integer times of msg1-FDM, the SSB to RO mapping pattern for each of the mapping cycles might not be aligned. As a result, when RO hopping is performed between these two mapping cycles, the frequency offset between two ROs mapped to one SSB might be different with another two ROs mapped to a different SSB. This may cause the frequency hopping operation misaligned among different ROs.

To handle this issue, it is proposed to revise the SSB to RO association such that the SSB to RO mapping pattern is same for the time period with each of K mapping cycles (instead of same mapping pattern for each SSB to RO association period as in legacy). For example, the SSB to RO mapping pattern for the time period with the first K mapping cycles (starting from frame 0) is first settled, and this pattern is used by other mapping cycles. In this way, the RO hopping may be performed for each of K mapping cycles (or for each mapping unit), and the hopping operations between any two ROs mapped to a same SSB is aligned.

For the SSB to RO association for each mapping cycle, for example, a definition of RO hopping period is proposed, which contain K SSB to RO mapping cycles. The SSB to RO mapping pattern is same in each RO hopping period. The ROs in the period that are not mapped to any SSBs are unused ROs, and they are not used for PRACH transmission. In such a way, the RO hopping may be performed every RO hopping period.

Herein, when the number of ROs in a mapping unit is not an integer multiplexes of msg-FDM, misaligned hopping offset may be resulted with the legacy SSB to RO association and a new SSB to RO association will be determined to avoid the issue will be illustrated.

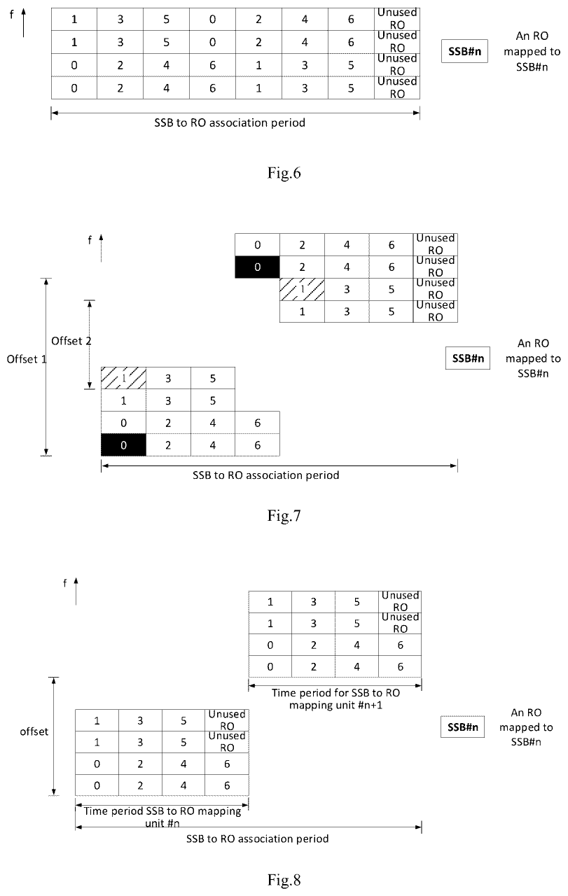

Only for illustrative purposes, FIG. 6 illustrates an example SSB to RO association in an SSB to RO association period. In the example, N_SSB=7, msg1-FDM=4, SSB-perRACH-Occasion=½. M=(N_SSB/SSB-perRACH-Occasion)=14, and in such a case, M/msg 1-FDM=14/4 is not an integer value. The legacy SSB to RO is shown in FIG. 6, from which it is clear that there are 4 unused ROs in the association period.

FIG. 7 illustrates example SSB to RO mapping patterns without changing the legacy SSB to RO association. The resulted misaligned RO hopping offset between two groups of ROs that are mapped to different SSBs. The two ROs in group #1 are mapped to SSB#0, and PRACH repetition in these two ROs uses frequency offset 1, while for the two ROs in group #2, mapped to SSB#1, and PRACH repetition in these two ROs uses frequency offset 2.

In some embodiments, the terminal device 110 may perform the SSB to RO mapping in a frequency hopping period corresponding to one SSB to RO mapping unit. The ROs in the frequency hopping period that are not mapped to any SSBs may be unused ROs.

FIG. 8 illustrates example SSB to RO mapping patterns with changing the legacy SSB to RO association according to some embodiments of the present disclosure. The SSB to RO mapping pattern is same for hopping period containing one SSB to RO mapping unit (corresponding to K=2 mapping cycles). The SSB to RO mapping units has the same mapping pattern, and two ROs in the hopping period that does not map to any SSBs are unused and are located at the same position in the pattern. With the new mapping scheme, the hopping offset between any two ROs mapped to a same SSB will be aligned well.

In such a way, misaligned RO hopping offset may be avoided and the PRACH repetition may be performed using the frequency hopping in a more efficient way.

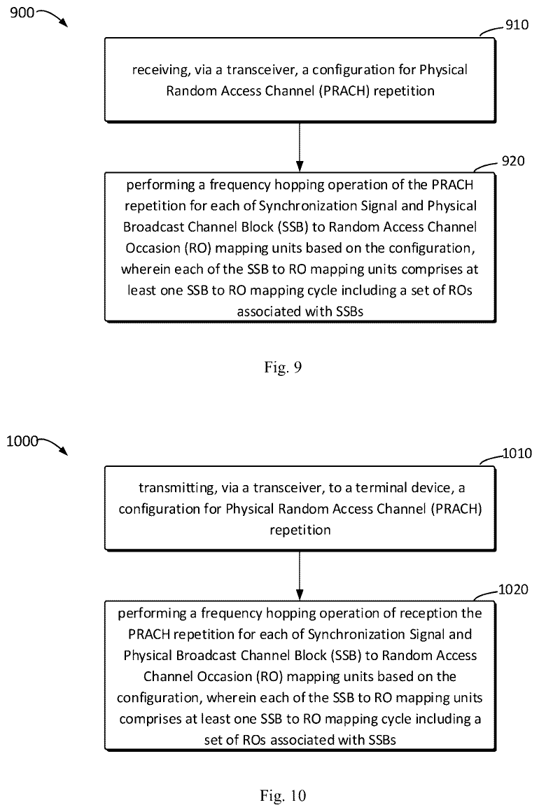

FIG. 9 illustrates a flowchart of a method implemented at a terminal device according to some embodiments of the present disclosure. In some embodiments, the method 900 can be implemented at a communication device, such as the terminal device 110 as shown in FIG. 1A. In some other embodiments, the method 900 may be implemented at devices not shown in FIG. 1A. Further, it is to be understood that the method 900 may include additional blocks not shown and/or may omit some blocks as shown, and the scope of the present disclosure is not limited in this regard. For the purpose of discussion, the method 900 will be described from the perspective of the terminal device 110 with reference to FIG. 1A.

At block 910, the terminal device 110 receives, via a transceiver, a configuration for Physical Random Access Channel (PRACH) repetition. At block 920, the terminal device 110 performs a frequency hopping operation of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In some embodiments, the terminal device 110 may determine a set of ROs for PRACH repetition, wherein each RO in the set of ROs is mapped to a same SSB. The terminal device 110 may determine the SSB to RO mapping unit for each RO in the set of ROs for PRACH repetition.

In some embodiments, the terminal device 110 may determine a frequency position of an RO in a SSB to RO mapping unit based on an index of the SSB to RO mapping unit.

In some embodiments, the terminal device 110 may determine the frequency position of the RO in the SSB to RO mapping unit from a start frequency position of the RO in the SSB to RO mapping unit and a frequency offset based on the index of the SSB to RO mapping unit.

In some embodiments, the start frequency position of the RO in the SSB to RO mapping unit may be determined by at least a start frequency position for the PRACH repetition.

In some embodiments, the terminal device 110 may be configured with a single frequency offset. Moreover, when the index of the SSB to RO mapping unit is even, the terminal device 110 may further determine the frequency position based on the start frequency position of the RO in the mapping unit. When the index of the SSB to RO mapping unit is odd, the terminal device 110 may further determine the frequency position based on the start frequency position of the RO in the mapping unit and the single frequency offset.

In some embodiments, the terminal device 110 may be configured with at least two offsets. Moreover, the terminal device 110 may further determine the frequency position from a result of mod the index of SSB to RO mapping unit by a number of the at least two offsets and the start frequency position for the PRACH repetition.

In some embodiments, the frequency hopping operation may be performed based on a number of SSB to RO mapping cycles in the SSB to RO mapping unit and a configured number of PRACH repetitions.

In some embodiments, the terminal device 110 may perform the frequency hopping operation when a number of SSB to RO mapping cycles in the SSB to RO mapping unit is less than or equal to the configured number of PRACH repetitions. Alternatively, the terminal device 110 may cancel the frequency hopping operation when the number of SSB to RO mapping cycles in the SSB to RO mapping unit is larger than the configured number of PRACH repetitions.

In some embodiments, a number of SSB to RO mapping cycles in an SSB to RO mapping unit may be either predefined, or configured, or determined by at least one of: a number of SSBs configured for mapping of configured ROs, a number of ROs multiplexed in frequency domain, and a number of SSBs mapped to a single RO.

In some embodiments, a number of ROs per SSB to RO mapping cycle may be less than or equal to the number of ROs in frequency domain, the terminal device 110 may determine the number of SSB to RO mapping cycles in the SSB to RO mapping unit as a ratio of the number of ROs multiplexed in frequency domain and the number of ROs per SSB to RO mapping cycle.

In some embodiments, the number of ROs per SSB to RO mapping cycle may be equal to the number of SSBs configured for mapping of configured ROs. Alternatively, the number of ROs per SSB to RO mapping cycle may be equal to a ratio of the number of SSBs configured for mapping of configured ROs and the number of SSBs mapped to a single RO.

In some embodiments, the number of ROs per SSB to RO mapping cycle may be larger than the number of ROs in frequency domain. Moreover, the terminal device 110 may further determine the number of SSB to RO mapping cycles in the SSB to RO mapping unit as a ratio of 1 and the number of SSBs mapped to a single RO, when the number of ROs in frequency domain is larger than 1. The terminal device 110 may further determine the number of SSB to RO mapping cycles in the SSB to RO mapping unit as 1, when the number of ROs in frequency domain is equal to 1 and the number of SSBs mapped to a single RO is larger than 1.

In some embodiments, each of the SSB to RO mapping units may have a same SSB to RO mapping pattern. The same mapping pattern may indicate a same number of ROs and a same SSB to RO association for each RO.

In some embodiments, SSB to RO mapping may be performed in a frequency hopping period corresponding to one SSB to RO mapping unit. The ROs in the frequency hopping period that are not mapped to any SSBs may be unused ROs.

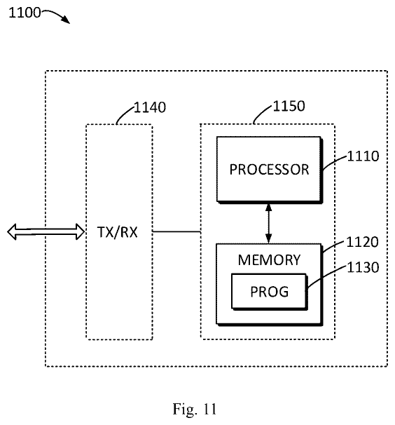

FIG. 10 illustrates a flowchart of a method implemented at a network device according to some embodiments of the present disclosure. In some embodiments, the method 1000 can be implemented at a communication device, such as the network device 120 as shown in FIG. 1A. In some other embodiments, the method 1000 may be implemented at devices not shown in FIG. 1A. Further, it is to be understood that the method 1000 may include additional blocks not shown and/or may omit some blocks as shown, and the scope of the present disclosure is not limited in this regard. For the purpose of discussion, the method 1000 will be described from the perspective of the network device 120 with reference to FIG. 1A.

At block 1010, the network device 120 transmits, via a transceiver, to a terminal device, a configuration for Physical Random Access Channel (PRACH) repetition. At block 1020, the network device 120 performs a frequency hopping operation of reception of the PRACH repetition for each of Synchronization Signal and Physical Broadcast Channel Block (SSB) to Random Access Channel Occasion (RO) mapping units based on the configuration, wherein each of the SSB to RO mapping units comprises at least one SSB to RO mapping cycle including a set of ROs associated with SSBs.

In some embodiments, the network device 120 may determine a set of ROs for PRACH repetition, wherein each RO in the set of ROs is mapped to a same SSB. The network device 120 may determine the SSB to RO mapping unit for each RO in the set of ROs for PRACH repetition.

In some embodiments, the network device 120 may determine a frequency position of an RO in a SSB to RO mapping unit based on an index of the SSB to RO mapping unit.

In some embodiments, the network device 120 may determine the frequency position of the RO in the SSB to RO mapping unit from a start frequency position of the RO in the SSB to RO mapping unit and a frequency offset based on the index of the SSB to RO mapping unit.

In some embodiments, the start frequency position of the RO in the SSB to RO mapping unit may be determined by at least a start frequency position for the PRACH repetition.

In some embodiments, the network device 120 may be configured with a single frequency offset. Moreover, when the index of the SSB to RO mapping unit is even, the network device 120 may further determine the frequency position based on the start frequency position of the RO in the mapping unit. When the index of the SSB to RO mapping unit is odd, the network device 120 may further determine the frequency position based on the start frequency position of the RO in the mapping unit and the single frequency offset.

In some embodiments, the network device 120 may be configured with at least two offsets. Moreover, the network device 120 may further determine the frequency position from a result of mod the index of SSB to RO mapping unit by a number of the at least two offsets and the start frequency position for the PRACH repetition.

In some embodiments, the frequency hopping operation may be performed based on a number of SSB to RO mapping cycles in the SSB to RO mapping unit and a configured number of PRACH repetitions.

In some embodiments, the network device 120 may perform the frequency hopping operation when a number of SSB to RO mapping cycles in the SSB to RO mapping unit is less than or equal to the configured number of PRACH repetitions. Alternatively, the network device 120 may cancel the frequency hopping operation when the number of SSB to RO mapping cycles in the SSB to RO mapping unit is larger than the configured number of PRACH repetitions.

In some embodiments, a number of SSB to RO mapping cycles in the SSB to RO mapping unit may be either predefined, or configured, or determined by at least one of: a number of SSBs configured for mapping of configured ROs, a number of ROs multiplexed in frequency domain, and a number of SSBs mapped to a single RO.

In some embodiments, a number of ROs per SSB to RO mapping cycle may be less than or equal to the number of ROs in frequency domain. The network device 120 may determine the number of SSB to RO mapping cycles in the SSB to RO mapping unit as a ratio of the number of ROs multiplexed in frequency domain and the number of ROS per SSB to RO mapping cycle.

In some embodiments, the number of ROs per SSB to RO mapping cycle may be equal to the number of SSBs configured for mapping of configured ROs. Alternatively, the number of ROs per SSB to RO mapping cycle may be equal to a ratio of the number of SSBs configured for mapping of configured ROs and the number of SSBs mapped to a single RO.

In some embodiments, the number of ROs per SSB to RO mapping cycle may be larger than the number of ROs in frequency domain. Moreover, the network device 120 may further determine the number of SSB to RO mapping cycles in the SSB to RO mapping unit as a ratio of 1 and the number of SSBs mapped to a single RO, when the number of ROs in frequency domain is larger than 1. The network device 120 may further determine the number of SSB to RO mapping cycles in the SSB to RO mapping unit as 1, when the number of ROs in frequency domain is equal to 1 and the number of SSBs mapped to a single RO is larger than 1.

In some embodiments, each of the SSB to RO mapping units may have a same SSB to RO mapping pattern. The same mapping pattern may indicate a same number of ROs and a same SSB to RO association for each RO.

In some embodiments, SSB to RO mapping may be performed in a frequency hopping period corresponding one SSB to RO mapping unit. The ROs in the frequency hopping period that are not mapped to any SSBs may be unused ROs.

### EXAMPLE APPARATUS

FIG. 11 illustrates a simplified block diagram of a device 1100 that is suitable for implementing embodiments of the present disclosure. The device 1100 can be considered as a further example implementation of the terminal device 110, and the network device 120 as shown in FIG. 1A. Accordingly, the device 1100 can be implemented at or as at least a part of the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 1130 is assumed to include program instructions that, when executed by the associated processor 1110, enable the device 1100 to operate in accordance with the embodiments of the present disclosure, as discussed herein with reference to FIGS. 1-11. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, an apparatus capable of performing the method 900 (for example, the terminal device 110) may comprise means for performing the respective steps of the method 900. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 900.

In some embodiments, an apparatus capable of performing the method 1000 (for example, the network device 120) may comprise means for performing the respective steps of the method 1000. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 1000.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device for wireless communication, comprising:
at least one memory; and
at least one processor coupled with the at least one memory and configured to cause the terminal device to:
receive a configuration for physical random access channel (PRACH) repetition; and
perform a frequency hopping operation of the PRACH repetition for each of synchronization signal and physical broadcast channel block (SSB) to random access channel occasion (RO) mapping units based on the configuration, wherein each of the SSB to RO mapping units comprises at least one SSB to RO mapping cycle including a set of ROS associated with SSBs.

2. The terminal device of claim 1, wherein the at least one processor is further configured to cause the terminal device to:
determine a set of ROs for PRACH repetition, wherein each RO in the set of ROS is mapped to a same SSB; and
determine the SSB to RO mapping unit for each RO in the set of ROs for the PRACH repetition.

3. The terminal device of claim 2, wherein the at least one processor is further configured to cause the terminal device to determine a frequency position of an RO in a SSB to RO mapping unit based on an index of the SSB to RO mapping unit.

4. The terminal device of claim 3, wherein, to determine the frequency position of the RO in the SSB to RO mapping unit, the at least one processor is further configured to cause the terminal device to determine the frequency position of the RO in the SSB to RO mapping unit from a start frequency position of the RO in the SSB to RO mapping unit and a frequency offset based on the index of the SSB to RO mapping unit.

5. The terminal device of claim 4, wherein the start frequency position of the RO in the SSB to RO mapping unit is determined by at least a start frequency position for the PRACH repetition.

6. The terminal device of claim 4, wherein the terminal device is configured with a single frequency offset, and wherein, to determine the frequency position of the RO in the SSB to RO mapping unit, the at least one processor is further configured to cause the terminal device to:
when the index of the SSB to RO mapping unit is even, determine the frequency position based on the start frequency position of the RO in the SSB to RO mapping unit; and
when the index of the SSB to RO mapping unit is odd, determine the frequency position based on the start frequency position of the RO in the SSB to RO mapping unit and the single frequency offset.

7. The terminal device of claim 4, wherein, to determine the frequency position of the RO in the SSB to RO mapping unit, the at least one processor is further configured to cause the terminal device to determine the frequency position from a result of mod the index of SSB to RO mapping unit by a number of at least two offsets and the start frequency position for the PRACH repetition.

8. The terminal device of claim 4, wherein a number of SSB to RO mapping cycles in the SSB to RO mapping unit is either predefined, configured, or determined by at least one of:
a number of SSBs configured for mapping of configured ROS,
a number of ROs multiplexed in frequency domain, or
a number of SSBs mapped to a single RO.

9. The terminal device of claim 8, wherein:
a number of ROs per SSB to RO mapping cycle is less than or equal to the number of ROs multiplexed in the frequency domain; and
to determine the number of SSB to RO mapping cycles in the SSB to RO mapping unit, the at least one processor is configured to cause the terminal device to determine the number of SSB to RO mapping cycles in the SSB to RO mapping unit as a ratio of the number of ROs multiplexed in the frequency domain and the number of ROs per SSB to RO mapping cycle.

10. The terminal device of claim 9, wherein the number of ROs per SSB to RO mapping cycle is equal to the number of SSBs configured for mapping of configured ROs, or is equal to a ratio of the number of SSBs configured for mapping of configured ROs and the number of SSBs mapped to a single RO.

11. The terminal device of claim 8, wherein:
the number of ROs per SSB to RO mapping cycle is larger than the number of ROs in the frequency domain; and
to determine the number of SSB to RO mapping cycles in the SSB to RO mapping unit, the at least one processor is configured to cause the terminal device to:
determine the number of SSB to RO mapping cycles in the SSB to RO mapping unit as a ratio of one and the number of SSBs mapped to a single RO, when the number of ROs in the frequency domain is larger than one; and
determine the number of SSB to RO mapping cycles in the SSB to RO mapping unit as one, when the number of ROs in the frequency domain is equal to one and the number of SSBs mapped to a single RO is larger than one.

12. The terminal device of claim 1, wherein each of the SSB to RO mapping units has a same SSB to RO mapping pattern, and wherein the same mapping pattern indicates a same number of ROs and a same SSB to RO association for each RO.

13. The terminal device of claim 11, wherein SSB to RO mapping is performed in a frequency hopping period corresponding to one SSB to RO mapping unit, and wherein the ROs in the frequency hopping period that are not mapped to any SSBs are unused ROs.

14. A network device for wireless communication, comprising:
at least one memory; and
at least one processor coupled with the at least one memory and configured to cause the network device to:
transmit, to a terminal device, a configuration for physical random access channel (PRACH) repetition; and
perform a frequency hopping operation of reception of the PRACH repetition for each of synchronization signal and physical broadcast channel block (SSB) to random access channel occasion (RO) mapping units based on the configuration, wherein each of the SSB to RO mapping units comprises at least one SSB to RO mapping cycle including a set of ROs associated with SSBs.

15. A method performed by a terminal device, the method comprising:
receiving a configuration for PRACH, physical random access channel (PRACH) repetition; and
performing a frequency hopping operation of the PRACH repetition for each of synchronization signal and physical broadcast channel block (SSB) to random access channel occasion (RO) mapping units based on the configuration, wherein each of the SSB to RO mapping units comprises at least one SSB to RO mapping cycle including a set of ROs associated with SSBs.

16. The method of claim 15, further comprising:
determining a set of ROs for PRACH repetition, wherein each RO in the set of ROs is mapped to a same SSB; and
determining the SSB to RO mapping unit for each RO in the set of ROs for the PRACH repetition.

17. The method of claim 16, further comprising:
determining a frequency position of an RO in a SSB to RO mapping unit based on an index of the SSB to RO mapping unit.

18. The method of claim 17, wherein to determine the frequency position of the RO in the SSB to RO mapping unit, the method further comprising:
determining the frequency position of the RO in the SSB to RO mapping unit from a start frequency position of the RO in the SSB to RO mapping unit and a frequency offset based on the index of the SSB to RO mapping unit.

19. The method of claim 18, wherein the start frequency position of the RO in the SSB to RO mapping unit is determined by at least a start frequency position for the PRACH repetition.

20. A method performed by a network device, the method comprising:
transmitting, to a terminal device, a configuration for physical random access channel (PRACH) repetition; and
perform a frequency hopping operation of reception of the PRACH repetition for each of synchronization signal and physical broadcast channel block (SSB) to random access channel occasion (RO) mapping units based on the configuration, wherein each of the SSB to RO mapping units comprises at least one SSB to RO mapping cycle including a set of ROs associated with SSBs.
